(19) United States
(12) Patent Application Publication
(10) Pub. No.: US 2011/0087496 A1
(43) Pub. Date: Apr. 14, 2011

(54) METHOD AND APPARATUS FOR SELLING A SOFTWARE PRODUCT

(76) Inventor: Daniel Doll-Steinberg, London (GB)

(21) Appl. No.: 12/969,719

(22) Filed: Dec. 16, 2010

Related U.S. Application Data
(63) Continuation-in-part of application No. 10/488,605, filed on Aug. 9, 2004, now abandoned.

(51) Int. Cl. G06Q 30/00; G06F 17/00

(52) U.S. Cl. 705/1.1; 235/375

(57) ABSTRACT

A method and system for selling a software product, and for preventing theft at the point of purchase, includes: manufacturing the software product at a sales outlet; generating a unique unlock code for the product, without which the product will not operate; displaying the product for sale at the sales outlet, while storing the unlock code separately from the product; and, on purchase of the product by a customer, supplying the customer with both the product and the unlock code. Since the unlock code is not printed onto the packaging, nor is it burned to the CD or other machine-readable media, the product can safely be left out for display and purchase in store without substantial risk of theft.

### CROSS-REFERENCE TO RELATED APPLICATIONS

This is a continuation-in-part of co-pending application Ser. No. 10/488,605 filed Aug. 9, 2004, entitled “METHOD AND APPARATUS FOR SELLING A SOFTWARE PRODUCT”.

### TECHNICAL FIELD

The present disclosure relates to a method and apparatus for selling a software product, and in particular, to methods and apparatus which can protect products being displayed for sale from theft.

### BACKGROUND

Products in general, and in particular games, are typically very tempting to thieves when displayed on open shelves in a retail environment. Current methods of tackling this problem to reduce “shrinkage” include displaying the products in locked glass cabinets, and displaying empty boxes with the products themselves being kept in a secure area such as a storeroom or behind the sales desk. The first approach is, however, unattractive to the customer who is unable to “browse”; while the second is unattractive to the retailer since it requires additional storage space and the time taken to match up an empty box with its corresponding product can slow down the sales process.

Another approach, which has been used with some success, is to provide a small software manufacturing facility within the retail outlet, so that software titles may be manufactured on demand. Typically, that would include a CD or DVD burner, along with a high-quality printer to print the packaging and/or a manual. On-demand manufacturing (i.e. producing the product as it is sold) does however take a little time, and customers are not always prepared to wait for the title they wish to purchase to be burned onto CD. It often proves convenient in practice for stores to bulk-manufacture at least certain titles, for example daily or weekly, and to put those pre-manufactured titles out on the shelves for customers to browse and purchase in the normal way. But in doing so, the retailer greatly increases the risk of theft or “shrinkage” of the manufactured inventory.

### SUMMARY

In one embodiment, a method of manufacturing and selling a software product both locally at a sales outlet for a customer is disclosed. The method may comprise one or more acts of: providing at the sales outlet a manufacturing control unit connected to a product manufacturing apparatus, a printer and a storage device; using the product manufacturing apparatus under the control of the manufacturing control unit at the sales outlet to write a software title to a machine-readable medium to manufacture an individual software product comprising the machine-readable medium with the software title, and when manufacturing the individual software product the manufacturing control unit: generates and stores on the machine-readable medium a unique identifier for the individual software product, prints the unique identifier using the printer on packaging for the software product, generates for each individual software product manufactured an associated unique unlock code without which the individual software product will not operate, and stores on the storage device, with the unique identifier for the individual software product, the associated unique unlock code; associating the software product with the packaging having the unique identifier printed thereon; leaving out for sale at the sales outlet the software product in the packaging; and upon purchase of the software product at the sales outlet by the customer, recovering from the storage device the associated unique unlock code for the individual software product by using the unique identifier printed on the packaging, and supplying the customer with both the software product and the associated unique unlock code.

In another embodiment, a system for manufacturing and selling a software product to a customer is disclosed. The system may comprise a sales outlet which is visited by the customer, said sales outlet may have one or more of: a product manufacturing apparatus; a printer; a storage device containing data corresponding to a software title to be written to a machine-readable medium; a manufacturing control unit connected to the a product manufacturing apparatus, the printer, and the storage device, in which the product manufacturing apparatus under the control of the manufacturing control unit writes the software title to the machine-readable medium to manufacture a software product comprising the machine-readable medium with the software title, and the manufacturing control unit: generates and stores on the machine-readable medium a unique identifier for the software product, prints the unique identifier using the printer on packaging for the software product, generates for each individual software product manufactured an associated unique unlock code without which the individual software product will not operate, and stores on the storage device, with the unique identifier for the individual software product, the associated unique unlock code; means for recovering from the storage device the corresponding unlock code which uses the unique identifier printed on packaging; and means for printing out the corresponding unlock code recovered from the storage device such that on purchase of the software product the customer is supplied with both the software product and the print out of the corresponding unlock code at the sales outlet.

These and further features and advantages of these and other embodiments of the invention will appear more fully from the following description and the accompanying drawings.

### BRIEF DESCRIPTION OF THE DRAWING

FIG. 1 depicts a system and method for manufacturing and selling a software product to a customer, e.g., at a sales outlet which is visited by the customer.

### DETAILED DESCRIPTION

Embodiments according to the present invention provide a system and method of selling a software product in which the risk of theft is reduced.

In one embodiment there is disclosed a method of selling a software product, comprising: (a) manufacturing the product; (b) generating a unique unlock code for the product, without which the product will not operate; (c) displaying the product for sale at a sales outlet, while storing the unlock code separately from the product; and (d) on purchase of the product by a customer, supplying the customer with both the product and the unlock code.

In another embodiment, there is disclosed a system for selling a software product, comprising: (a) means for manufacturing the product; (b) means for generating a unique unlock code for the product, without which the product will not operate; (c) storage means for storing the unlock code separately from the product, while the product is displayed for sale at a sales outlet; and (d) means for supplying the unlock code to a customer, on purchase of the product.

In some embodiments, the product is manufactured at the sales outlet where it is to be displayed for sale.

The software product itself will typically comprise a CD, DVD, magnetic disk or other machine-readable media on which is stored a software title or program. In some embodiments, the program is so configured that it cannot be loaded, or alternatively it cannot be run, without the entry of an unlock code.

The unlock code may be generated randomly, or at least partly randomly, when the product is manufactured or is ready to be manufactured at the sales outlet. Each individual product (e.g. the content of each individual CD or DVD) is unique and as its own specific unlock code which will release only that particular copy.

When a software product is purchased, the unlock code may be retrieved from a local store, printed out, and supplied to the customer in printed form. In one embodiment, the unlock code may be printed onto an adhesive label which may then be secured to the product. This has the advantage that the adhesive label may be removed, if the product is later returned by the customer, and the same product then put back out onto the shelves for re-display and resale.

In some embodiments, the unlock code is stored in a database, held locally at the sales outlet. The information may be stored indefinitely if required but, in some embodiments, to reduce local storage requirements the code may be deleted once the product has been purchased. A permanent record of the unlock code may be transmitted from the sales outlet (for example on manufacture of the product) to a remote control centre.

If an unlock code is later required, and is not obtainable in-store, the store can then send a request to the control centre for the number to be supplied; such a request may be flagged at the centre to reduce the risk of fraud (e. g. to prevent the same unlock code being retrieved numerous times).

Retrieval from the control centre is permitted only on further proof of purchase being supplied to the sales outlet staff. Any attempt to retrieve a code for an unsold product may be identified to staff.

In some embodiments, the software product also has a unique identifier associated with it, for example a license number. The unlock code may be stored against a unique identifier in the local database, and also in the central database at the control centre. The databases may be interrogated, and an unlock code supplied, on the basis of a known unique identifier.

In some embodiments, the unique identifier is electronically stored in machine-readable form within the product, for example by burning the license number onto a CD. The unique identifier may also be printed onto the packaging or documentation associated with the product, either in human readable form or in machine-readable form such as a bar code. Then, when an intending customer goes to the cash desk with a product for purchase, the sales assistant simply scans the bar code corresponding to the license number, retrieves the unlock code and prints it out for supply to the customer along with the product. The sale information may then be transmitted to the control centre, which may keep track of all transactions under the system, including manufacture of products, sales, release of unlock keys, and returns.

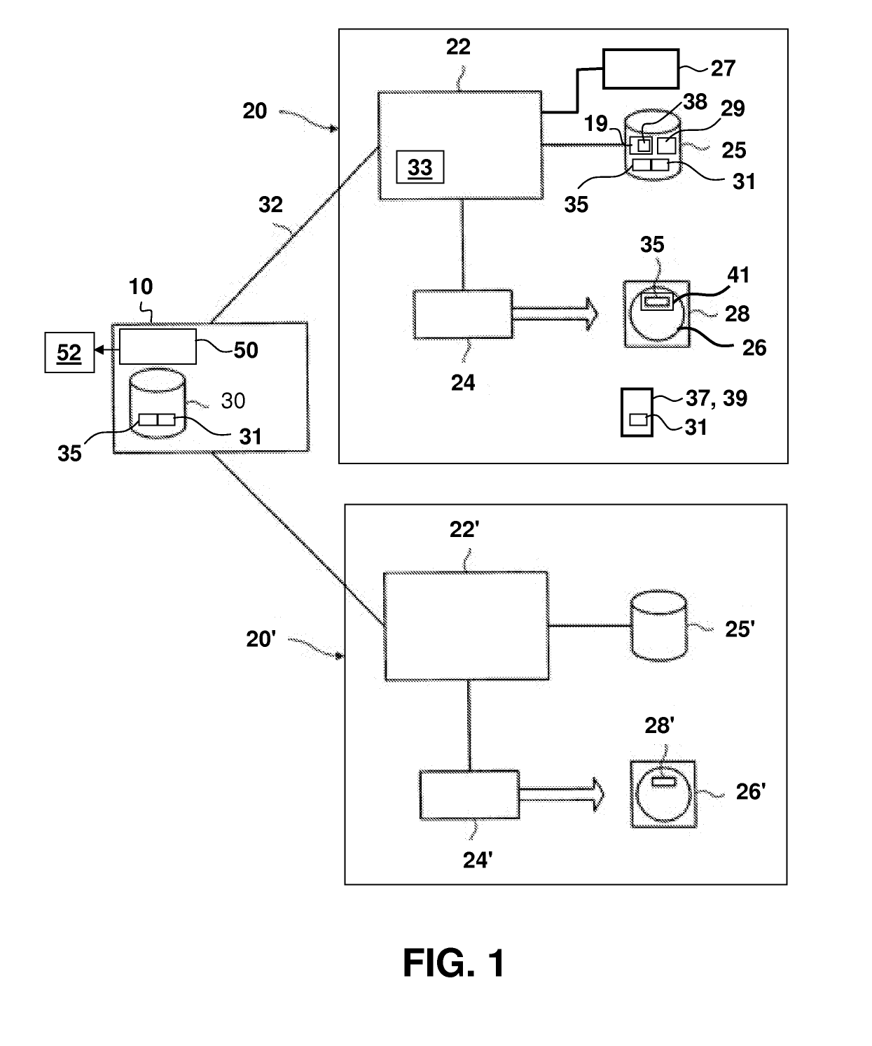

The various embodiments of the invention may be carried into practice in a number of ways and one method and apparatus will now be described, by way of example, with reference to FIG. 1, which schematically shows the system according to one embodiment.

Referring to FIG. 1, a control centre 10 is in communication with a number of retail outlets 20, 20′, of which only two are shown in the drawing, for clarity. Communication between the retail outlets and the control centre may be via the internet, a direct-dial telephone connection or any other convenient channel 32.

Each of the retail outlets is similar, and accordingly only the retail (or sales) outlet 20 will be described in detail. The outlet 20 has a manufacturing control unit 22, typically consisting of a PC or other computer running appropriate software, and a product manufacturing apparatus 24. The latter includes a CD or DVD burner for generating a physical machine-readable software product or disk 26, along with printers 27 for printing product packaging 28 and/or a manual (not shown). The product manufacturing apparatus 24 is controlled by the manufacturing control unit 22, with the software title or program 19 to be written to disk 26 and the data 29 to be printed taken from a database or large local hard disk drive 25 or other electronic storage facility, accessible directly and/or via a public and/or private network.

In the present embodiment, when a software product or disk 26 is manufactured with the software title or program 19, the manufacturing control unit 22 generates an associated unique unlock code 31, without which the software product or disk cannot be used. A unique code 31 is created for each individual software product or disk 26 that is manufactured. The unlock code 31 is generated at least partly by means of a random number generating algorithm or generator 33, to ensure uniqueness and difficulty of reproduction; it is then securely stored in a local database, e.g., the database or local hard disk drive 25, or elsewhere, linked to a product license number or other suitable unique identifier 35. That information is also reported back to the control centre 10, where it is stored in a central database 30.

Locking strength can be customized on a store-by-store basis with a key length of e.g. 2 to 32 characters. The character length of the unlock code 31 cannot then be predicted, as it is variable.

The manufactured software product or disk 26, along with any associated packaging 28 and manuals, can then safely be left out for display and purchase in the store.

Without the unlock code 31 (which is not burned to the disk 26 itself, or printed out on the packaging 28 or the manual) the software title or program 19 contained on the manufactured software product or disk 26 cannot be used: it may, for example, refuse to load, refuse to run, run only for a limited time or with limited functionality. A thief who steals the software product or disk 26 and then attempts to bring it back to the same store, or to another, for a “refund” will not succeed since by typing in the unique identifier 35 of the software product or disk 26 (which is burned to the DVD/CD and printed on the packaging 28) the shop assistant will be able to see that the particular software product or disk has never been legitimately purchased.

When a customer comes to the sales desk with a software product or disk 26, chosen from the shelves, that he wishes to purchase, the sales assistant enters the product's unique license number or unique identifier 35 and retrieves the corresponding unlock code 31 from the database or local hard disk drive 25. The unlock code 31 is then printed out and supplied to the purchaser along with the software product or disk 26 (containing the software title or program 19) and the documentation, e.g., created from printing data 29. That could be done in any convenient way, for example printing the unlock code 31 on a separate insert sheet 37, to be slipped inside the product casing, or as a supplement to the manual, or on the sales receipt 39. Alternatively, the unlock code 31 could be printed onto a self-adhesive label 41 to be stuck by the sales assistant to the outside of the product packaging 28. The last approach has the advantage that, if the label 41 is removable, the label 41 can be removed and the software product or disk 26 put back onto the shelves for resale in the event that the product is later returned by the customer.

Removable labels could also be useful for retail outlets that may wish to sell second-hand titles.

Once the unlock code 31 has been properly entered the first time the software product or disk 26 is loaded and/or the software title or program 19 is run by the customer, the unlock code 31 is then stored in encrypted form on the user's machine, from where it can be automatically retrieved when the software title or program 19 is run again. The unlock code 31 thus only needs to be entered by the user once. In some embodiments, the unlock code 31 can be entered from the keyboard irrespective of Caps Lock, Control, Alt or Shift key combinations.

Once the unlock code 31 has been retrieved from the local database for a particular software product or disk 26, and that software product or disk 26 is sold, the code may then be deleted from the database, e.g. database or local hard disk drive 25, to reduce local storage requirements. Because all unlock codes 31 are held centrally at the control centre 10, any authorized retail outlet may have access to them, when required, and not only the store that actually made the sale. A customer who loses an unlock code 31 could be told what the code is by presenting suitable credentials, including the software product or disk 26 itself, at any authorized retail outlet, or by quoting a registered license number, e.g., the unique identifier 35, by telephone, email, internet web site, etc.

The control centre 10 monitors the entire process, and may arrange to invoice the individual retail outlets whenever a sale is made. For this purpose, a “sale” could correspond with the creation of the unlock code 31 (in other words, the local manufacture of a software product or disk 26), or with the retrieval of the unlock code 31 (in other words the actual sale of the software product or disk 26 to a customer). The license key never needs to be checked against any data held within the product content; and there is therefore nothing that can be intercepted by a hacker monitoring the process; the entered key is used to correct encrypted code in executable code in the software.

In some embodiments, software products or disks 26 left out for display and purchase in the store are marked as “protected” in some way, either on the packaging 28 or by means of a separate notice adjacent to the display.

The process used means that codes on the arrays used in store are always protected. Decoding takes place at the point of use of the software title or program 19; no interception is possible whilst data is in electronic transit. Once installed, the unlock code 31 can be recorded on the customer's device, e.g., a personal computer's hard disc, so that it does not need to be re-installed.

In another embodiment, the products or disks 26 may be manufactured at a central or clustered manufacturing facility, away from the store, with the products or disks 26 being shipped to the store in the normal way, pre-packaged in packaging 28 and ready for display.

The process can be applied to Microsoft, Mac and Unix operating systems (but not limited to these three).

In other embodiments, when a software product or disk 26 is purchased, the unlock code 31 may be retrieved from a local store, and applied to the product at the sales outlet. The machine-readable media on which the software title or program 19 is stored may additionally have the unlock code 31 added to media. This has the advantage that a software title or program 19 so configured can obtain the unlock code 31 from the media without requiring manual entry of an unlock code by a customer, thus improving the experience for the customer.

In other embodiments, the unlock code 31 may be generated at least partly for a piece of content or program code 38 removed from the software title or program 19. This has the advantage that the software title or program 19 is missing a piece of content or program code 38 until the unlock code 31 is provided, making the software product or disk 26 left out for display even more secure if stolen.

In still other embodiments, when a software product or disk 26 is purchased, the unlock code 31 may be retrieved from a local store and/or supplied to the customer electronically. This has the advantage of allowing for a larger unlock code 31 and the customer not having to manually enter in the unlock code. In one embodiment of the invention, the unlock code 31 or details of how to download the unlock code 31 may be emailed to the customer, e.g., via a mail server 40 providing an email 42. In another embodiment of the invention, the unlock code 31 is made available on an internet website 50 for the customer to download, with the customer being provided the internet website details such as, e.g., an internet address 52, when purchasing the software product or disk 26.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

What is claimed is:

1. A method of manufacturing and selling a software product both locally at a sales outlet for a customer, comprising:
providing at the sales outlet a manufacturing control unit connected to a product manufacturing apparatus, a printer and a storage device;
using the product manufacturing apparatus under the control of the manufacturing control unit at the sales outlet to write a software title to a machine-readable medium to manufacture an individual software product comprising the machine-readable medium with the software title, and when manufacturing the individual software product the manufacturing control unit:
generates and stores on the machine-readable medium a unique identifier for the individual software product,
prints the unique identifier using the printer on packaging for the software product,
generates for each individual software product manufactured an associated unique unlock code without which the individual software product will not operate, and
stores on the storage device, with the unique identifier for the individual software product, the associated unique unlock code;
associating the software product with the packaging having the unique identifier printed thereon;
leaving out for sale at the sales outlet the software product in the packaging; and
upon purchase of the software product at the sales outlet by the customer,
recovering from the storage device the associated unique unlock code for the individual software product by using the unique identifier printed on the packaging, and
supplying the customer with both the software product and the associated unique unlock code.

2. A method of manufacturing and selling a software product both locally at a sales outlet visited by a customer, comprising:
providing at the sales outlet a manufacturing control unit connected to a product manufacturing apparatus, a printer, and a storage device containing data corresponding to a software title to be written to a machine-readable medium;
using the product manufacturing apparatus under the control of the manufacturing control unit at the sales outlet to write the software title to the machine-readable medium to manufacture an individual software product comprising the machine-readable medium with the software title, and when manufacturing the individual software product the manufacturing control unit:
generates and stores on the machine-readable medium a unique identifier for the individual software product,
prints the unique identifier using the printer on packaging for the software product,
generates for each individual software product manufactured an associated unique unlock code without which the individual software product will not operate, and
stores on the storage device, with the unique identifier for the individual software product, the associated unique unlock code;
associating the software product with the packaging having the unique identifier printed thereon;
leaving out for sale at the sales outlet the software product in the packaging; and
upon purchase of the software product at the sales outlet by the customer,
recovering from the storage device the associated unlock code for the individual software product by using the unique identifier printed on the packaging,
printing out the corresponding unlock code recovered from the storage device at the sales outlet, and
supplying the customer with both the software product and the print out of the associated unique unlock code at the sales outlet.

3. The method as claimed in claim 2 in which the unlock codes are generated randomly by the manufacturing control unit.

4. The method as claimed in claim 2 in which the print out of the corresponding unlock code is an adhesive label which is secured to the product.

5. The method as claimed in claim 2 in which the print out of the corresponding unlock code is provided on a sale receipt for the purchase of the software product.

6. The method as claimed in claim 2 further comprising deleting the corresponding unlock code from the local storage device on purchase of the product.

7. The method as claimed in claim 2 further comprising the manufacturing control unit transmitting the corresponding unlock code to a central database of a remote control centre.

8. The method as claimed in claim 2 in which the unique identifier is printed on the packaging as a bar code.

9. A system for manufacturing and selling a software product to a customer, comprising a sales outlet which is visited by the customer, said sales outlet having:
a product manufacturing apparatus;
a printer;
a storage device containing data corresponding to a software title to be written to a machine-readable medium;
a manufacturing control unit connected to the a product manufacturing apparatus, the printer, and the storage device, in which the product manufacturing apparatus under the control of the manufacturing control unit writes the software title to the machine-readable medium to manufacture a software product comprising the machine-readable medium with the software title, and the manufacturing control unit:
generates and stores on the machine-readable medium a unique identifier for the software product,
prints the unique identifier using the printer on packaging for the software product,
generates for each individual software product manufactured an associated unique unlock code without which the individual software product will not operate, and
stores on the storage device, with the unique identifier for the individual software product, the associated unique unlock code;
means for recovering from the storage device the corresponding unlock code which uses the unique identifier printed on packaging; and
means for printing out the corresponding unlock code recovered from the storage device such that on purchase of the software product the customer is supplied with both the software product and the print out of the corresponding unlock code at the sales outlet.

10. The system as claimed in claim 9 including a random number generator for at least partly generating the unlock code.

11. The system as claimed in claim 9 wherein the print out of the corresponding unlock code is an adhesive label for securement to the product.

12. The system as claimed in claim 9 wherein the print out of the corresponding unlock code is provided on a sale receipt for the purchase of the software product.

13. The system as claimed in claim 9 including means for deleting the corresponding unlock code from the local storage device on purchase of the software product.

14. The system as claimed in claim 9 including means for transmitting the corresponding unlock code for storage to a central database of a remote control centre.

15. The system as claimed in claim 9 wherein the unique identifier is printed on the packaging as a bar code.

16. The system as claimed in claim 9 including where the unlock code is applied to the software product at the sales outlet upon purchase by the customer.

17. The system as claimed in claim 9 including a piece of content removed from the software product for at least partly generating the unlock code.

18. The system as claimed in claim 9 in which the customer upon purchase is supplied an internet address to obtain the unlock code.

19. The system as claimed in claim 9 in which the customer upon purchase is delivered electronically the unlock code.
